(19) United States
(12) Patent Application Publication
(10) Pub. No.: US 2017/0342913 A1
(43) Pub. Date: Nov. 30, 2017

(54) GAS TURBINE ENGINE INLET TEMPERATURE SENSOR CONFIGURATION

(71) Applicant: United Technologies Corporation, Farmington, CT (US)

(72) Inventor: Matthew R. Feulner, West Hartford, CT (US)

(21) Appl. No.: 15/162,727

(22) Filed: May 24, 2016

(51) Int. Cl. F02C 9/48; F02C 3/04; F02C 7/32

(52) U.S. Cl. CPC F02C 9/48; F02C 7/32; F02C 3/04; F05D 2220/32; F05D 2270/313; F05D 2270/80; F05D 2270/312

(57) ABSTRACT

A gas turbine engine including a compressor, a combustor fluidly connected to the compressor via a primary flowpath, a turbine fluidly connected to the combustor via the primary flowpath, an engine controller communicatively coupled to at least one sensor in the gas turbine engine, the controller including a non-transitory memory and a processor, and the at least one sensor including an inlet temperature and/or pressure sensor, wherein the sensor is disposed aft of a fan.

### TECHNICAL FIELD

The present disclosure relates generally to configurations of gas turbine engines, and more specifically to an inlet temperature sensor configuration in a gas turbine engine.

### BACKGROUND

Gas turbine engines utilize a compressor to compress air, a combustor to mix the compressed air with a fuel and ignite the mixture, and a turbine across which the resultant combustion products are expanded. The expansion of the combustion products drives the turbine to rotate. The rotation of the turbine drives rotation of the compressor via a shaft. In some engines a fan, forward of the compressor, is also connected to the shaft via a gearing system.

The operations of a gas turbine engine, including compressor speeds, fan speeds, etc. depend on the specific operating conditions of the aircraft. By way of example, the fan speeds at take-off, climb, and altitude are varied because of the different requirements of each specific flight operation. Control of the engine operations is achieved via one or more general engine controllers, and is based off of multiple engine parameter inputs.

### SUMMARY OF THE INVENTION

In one exemplary embodiment a gas turbine engine includes a compressor, a combustor fluidly connected to the compressor via a primary flowpath, a turbine fluidly connected to the combustor via the primary flowpath, an engine controller communicatively coupled to at least one sensor in the gas turbine engine, the controller including a non-transitory memory and a processor, and the at least one sensor including an inlet temperature and/or pressure sensor, wherein the sensor is disposed aft of a fan.

In another exemplary embodiment of the above described gas turbine engine the gas turbine engine is a short inlet gas turbine engine.

In another exemplary embodiment of any of the above described gas turbine engines the memory stores instructions for causing the processor to synthesize a gas turbine engine inlet temperature based on a temperature at the sensor.

In another exemplary embodiment of any of the above described gas turbine engines the sensor is a temperature and a pressure sensor.

In another exemplary embodiment of any of the above described gas turbine engines the memory stores instructions for causing the processor to synthesize a gas turbine engine inlet pressure based on a pressure at the sensor.

In another exemplary embodiment of any of the above described gas turbine engines the sensor is mounted to a radially inward surface of a bypass duct.

In another exemplary embodiment of any of the above described gas turbine engines the sensor is mounted to a radially outward surface of a bypass duct.

In another exemplary embodiment of any of the above described gas turbine engines the sensor is mounted aft of a compressor inlet.

In another exemplary embodiment of any of the above described gas turbine engines the memory includes instructions for scheduling the gas turbine engine based on at least one of a temperature and a pressure at a location of the sensor.

In another exemplary embodiment of any of the above described gas turbine engines the sensor is aft of a bypass duct guide vane.

An exemplary method for scheduling engine operations for a gas turbine engine includes receiving at least one of a temperature and a pressure value from a sensor positioned aft of a fan, and scheduling engine operations based at least in part on the received one of the temperature and pressure value.

Another example of the above described exemplary method for scheduling engine operations for a gas turbine engine further includes synthesizing one of an inlet temperature and pressure of the gas turbine engine based on the received value, and wherein scheduling engine operations based at least in part on the received one of the temperature and pressure value includes scheduling engine operations based on the synthesized one of the inlet temperature and pressure.

In a further example of any of the above described exemplary methods for scheduling engine operations for a gas turbine engine synthesizing one of an inlet temperature and pressure of the gas turbine engine based on the received value includes synthesizing both an inlet temperature and an inlet pressure based on the received value.

In a further example of any of the above described exemplary methods for scheduling engine operations for a gas turbine engine the synthesized inlet temperature is a temperature of air at a gas turbine engine inlet forward of a fan section, relative to an expected direction of fluid flow through the gas turbine engine.

In a further example of any of the above described exemplary methods for scheduling engine operations for a gas turbine engine the synthesized inlet pressure is a pressure of air at a gas turbine engine inlet forward of a fan section, relative to an expected direction of fluid flow through the gas turbine engine.

In a further example of any of the above described exemplary methods for scheduling engine operations for a gas turbine engine synthesizing one of an inlet temperature and pressure includes accounting for at least one of an engine operational mode, an engine altitude and an engine fan speed by at least incorporating the one or more of the engine operational mode, the engine altitude and the engine fan speed as a variable in a synthesizing formula in a controller.

In one exemplary embodiment a gas turbine engine includes a short inlet fan section characterized by a lack of inlet temperature sensors, a sensor disposed aft of a fan, and a controller configured to synthesize a temperature and/or pressure of a fluid at an inlet of the short inlet fan section based on a temperature and/or pressure at the sensor.

In another exemplary embodiment of the above described gas turbine engine the sensor is further configured to sense both a temperature and pressure of a fluid, and wherein the controller is further configured to synthesize a temperature and a pressure of the fluid at the inlet of the short inlet fan section.

In another exemplary embodiment of any of the above described gas turbines engine the short inlet fan section is defined by a dimensional relationship L/D of between 0.2 and 0.45, where L is a distance from an inlet to a leading edge of at least one fan blade and D is a diameter of the fan.

In another exemplary embodiment of any of the above described gas turbines the sensor is disposed aft of a primary flowpath inlet

These and other features of the present invention can be best understood from the following specification and drawings, the following of which is a brief description.

### BRIEF DESCRIPTION OF THE DRAWINGS

FIG. 1 schematically illustrates an exemplary gas turbine engine.

FIG. 2 schematically illustrates a short inlet section of an exemplary gas turbine engine.

### DETAILED DESCRIPTION OF AN EMBODIMENT

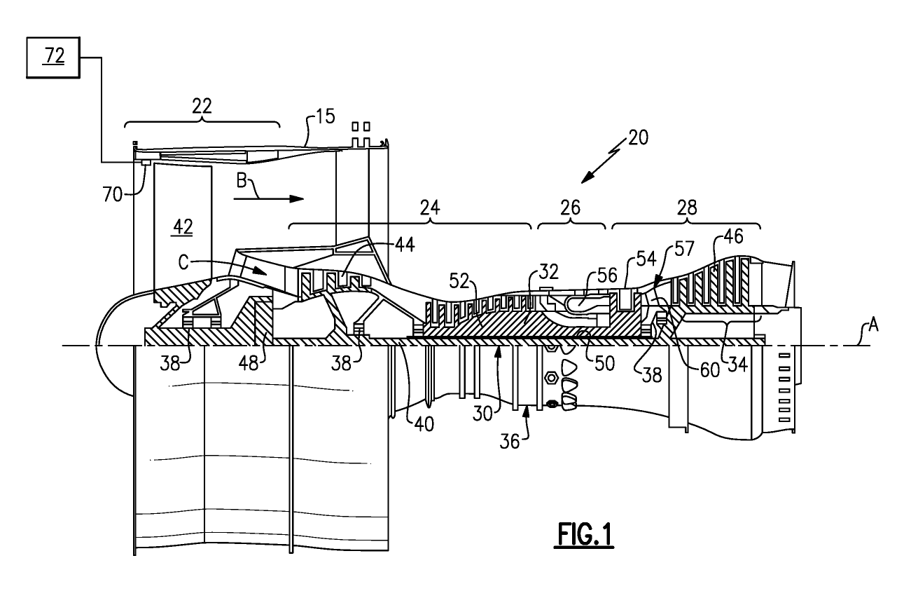

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

Low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five (5:1). Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (1066.8 meters). The flight condition of 0.8 Mach and 35,000 ft (1066.8 m), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]̂0.5. The “Low corrected fan tip speed” as disclosed herein according to one non-limiting embodiment is less than about 1150 ft/second (350.5 m/s).

Conventional gas turbine engines include one or more general engine controllers that receive inputs from multiple engine sensors. The data provided from the engine sensors is then utilized by the controller to schedule engine performance, depending on the particular operating parameters of the engine. One such example is an inlet temperature sensor 70. The inlet temperature sensor 70 is typically positioned forward of the fan 42, on a radially inward facing surface 122 of the nacelle 120. The inlet temperature sensor 70 determines the temperature and pressure of air that is entering the gas turbine engine 20, and provides the determined values to a general engine controller 72. The general engine controller 72 then schedules engine operations based on the determined values, as well as other sensor measurements from the engine 20.

The inlet temperature sensor 70 is positioned sufficiently aft of the inlet that the air speed at the sensor location is reduced to tolerable levels. At the same time, the inlet temperature sensor 70 is positioned sufficiently forward of the fan that turbulence resulting from the rotation of the fan 42 does not meaningfully impact the sensor readings. These conflicting positional requirements generate an axial positioning window in which the inlet temperature sensor 70 can be suitably positioned. In certain gas turbine engines, such as short inlet gas turbine engines, the conflicting requirements of low airspeed and low turbulence result in a lack of suitable positions of the inlet temperature sensor forward of the fan 42 (i.e. the axial positioning window is either too short or non-existent).

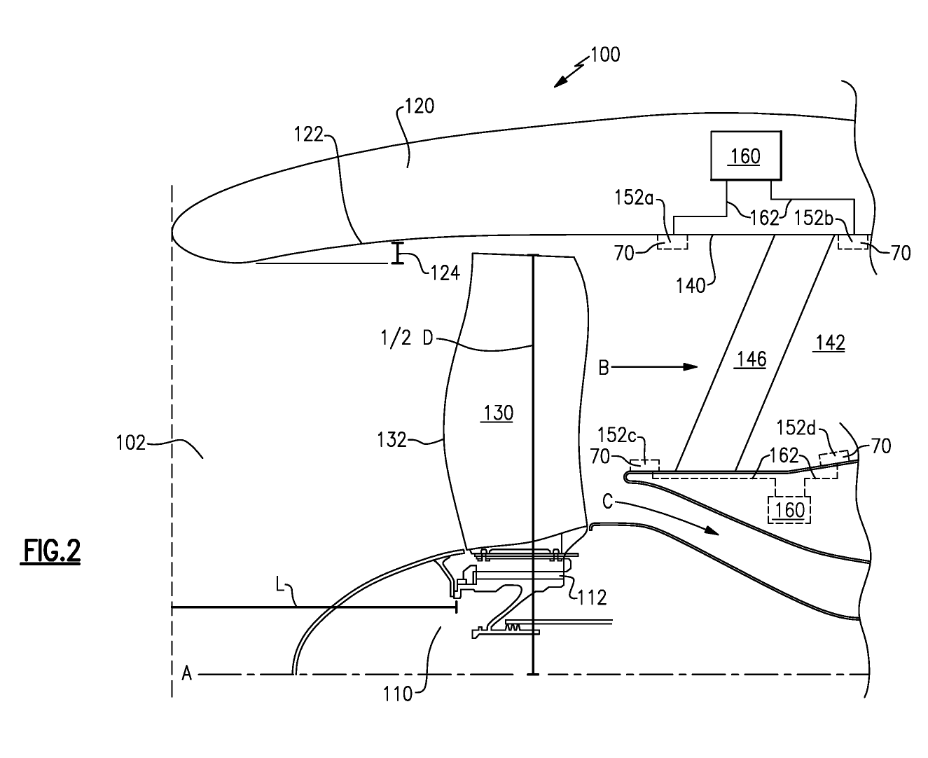

FIG. 2 schematically illustrates a fan section 100 of an example gas turbine engine. The exemplary fan section 100 is a short inlet low pressure ratio fan section. A diameter of the fan has a dimension D (one half of dimension D is shown in FIG. 2). The dimension D is based on a dimension of the fan blades 130. Each fan blade 130 has a leading edge 132. An inlet 102 is situated forward of the fan. A length of the inlet 102 has a dimension L between a location of the leading edge 132 of at least some of the fan blades 130 and a forward edge of the inlet 102. A dimensional relationship of L/D is between about 0.2 and about 0.45. In a further example, the engine has a high bypass ratio and the fan is a low pressure ratio fan having a pressure ratio between about 1.20 and about 1.50 at its cruise design point. As used herein, the term “short inlet” refers to any gas turbine engine inlet having the above described dimensional relationship of L/D of between about 0.2 and about 0.45.

The fan section 100 includes a radially outward fan nacelle 120. Multiple fan blades 130 protrude radially outward from a hub 110 to form the fan. The fan nacelle 120 includes a radially inward facing surface referred to as the inner diameter 122. The inner diameter of 122 of the fan nacelle 120 extends beyond the fan to form the outer diameter surface 140 of a bypass flowpath 142, alternately referred to as a bypass duct.

Aft of the fan 130, the flowpath is split between a primary engine flowpath C and a bypass flowpath B. A guide vane 146 structurally supports the inner and outer diameters of the bypass flowpath B, and maintains proper relative radial positions of the engine structures. In some examples, a bifurcation strut can be included downstream of the guide vane 146 and include pass throughs allowing signal wires, cooling passages, and the like, to pass through the bypass flowpath B from the inner diameter to the outer diameter, or vice versa. The guide vane 146 includes a flow correcting profile. The flow correcting vane or profile imparts desirable flow characteristics on the air passing through the bypass flowpath B.

As described above, the characteristics of a short inlet gas turbine engine render the region forward of the fan 130 unsuitable for including an inlet temperature sensor. As a result, the inlet temperature sensor 70 is located in one of four potential inlet temperature sensor positions 152a-d. The first sensor position 152a is forward of the guide vane 146 and on a radially outward surface of the bypass flowpath B. The second position 152b is aft of the guide vane 146 and on a radially outward surface of the bypass flowpath B. The third sensor position 152c is forward of the guide vane 146 and on a radially inward surface of the bypass flowpath B. The fourth sensor position 152d is aft of the guide vane 146 and on a radially inward surface of the bypass flowpath B. Each of the sensor positions 152a-d is connected to a general engine controller 160 via a communication line 162. The general engine controller 160 can be in either the illustrated position, or in any other position within the gas turbine engine 20. In some examples, the sensor position 152a-d is aft of the compressor inlet for the primary flowpath C. In yet further examples, the inlet temperature sensor 70 can be positioned on a surface of the bypass duct bifurcation, and operate in a similar faction as the four above described locations.

The inlet temperature sensor 70 detects a temperature and, in some examples, a pressure, of the fluid passing through the bypass flowpath B at the position 152a-d of the inlet temperature sensor. The rotation of the fan 130 affects the temperature and pressure of the air at each of the inlet sensor locations 152a-d. The specific affect on the temperature and pressure is dependent upon the rotational speed of the fan 130, the operating conditions of the engine, and any number of other knowable factors. Based on the known and knowable factors, as well as the sensed temperature, the controller 160 synthesizes a temperature value representative of the temperature at the inlet 102 of the gas turbine engine 20. In some examples the synthesizing of a temperature or pressure includes accounting for one or more operating condition variables, such as engine operational mode, engine altitude, current fan speed, and the like, by at least incorporating one or more operating condition variables in a synthetization process. The synthesized temperature is then utilized by the controller 160 to schedule engine operations.

In some examples, the temperature sensor also detects a pressure of the fluid passing through the bypass flowpath B at the location 152a-d of the sensor. The controller 160 can synthesize the pressure of the fluid at the inlet 102 of the gas turbine engine 20 in the same manner as the temperature is synthesized, and the synthesized pressure value is used by the controller 160 to schedule engine operations.

In alternative examples, the controller 160 is configured to schedule engine operations based directly on the bypass flowpath temperature, the bypass flowpath pressure, or both. In such an example, the controller 160 does not synthesize the inlet temperature and pressure, but rather directly uses the sensed conditions at the sensor locations 152a-d to schedule the engine operations.

With continued reference to FIGS. 1 and 2, in some examples the controller 160 schedules engine operations based on an aircraft-supplied temperature and pressure. In such examples, the temperature and/or pressure provided by the sensors 70 described herein are utilized as a backup source of inlet temperature and inlet pressure in case the controller 160 determines the sensors 70 to be fault.

While described above with specific regards to a short inlet gas turbine engine, one of skill in the art, having the benefit of this disclosure will understand that the inlet temperature sensor configurations described and illustrated herein can be applied to any gas turbine engine, and are not limited in application to a short inlet gas turbine engine.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
a compressor;
a combustor fluidly connected to the compressor via a primary flowpath;
a turbine fluidly connected to the combustor via the primary flowpath;
an engine controller communicatively coupled to at least one sensor in the gas turbine engine, the controller including a non-transitory memory and a processor; and
the at least one sensor including an inlet temperature and/or pressure sensor, wherein the sensor is disposed aft of a fan.

2. The gas turbine engine of claim 1, wherein the gas turbine engine is a short inlet gas turbine engine.

3. The gas turbine engine of claim 1, wherein said memory stores instructions for causing said processor to synthesize a gas turbine engine inlet temperature based on a temperature at said sensor.

4. The gas turbine engine of claim 1, wherein said sensor is a temperature and a pressure sensor.

5. The gas turbine engine of claim 4, wherein said memory stores instructions for causing said processor to synthesize a gas turbine engine inlet pressure based on a pressure at said sensor.

6. The gas turbine engine of claim 1, wherein the sensor is mounted to a radially inward surface of a bypass duct.

7. The gas turbine engine of claim 1, wherein the sensor is mounted to a radially outward surface of a bypass duct.

8. The gas turbine engine of claim 1, wherein the sensor is mounted aft of a compressor inlet.

9. The gas turbine engine of claim 1, wherein said memory includes instructions for scheduling said gas turbine engine based on at least one of a temperature and a pressure at a location of the sensor.

10. The gas turbine engine of claim 1, wherein the sensor is aft of a bypass duct guide vane.

11. A method for scheduling engine operations for a gas turbine engine comprising:
receiving at least one of a temperature and a pressure value from a sensor positioned aft of a fan; and
scheduling engine operations based at least in part on the received one of the temperature and pressure value.

12. The method of claim 11, further comprising synthesizing one of an inlet temperature and pressure of the gas turbine engine based on the received value, and wherein scheduling engine operations based at least in part on the received one of the temperature and pressure value includes scheduling engine operations based on the synthesized one of the inlet temperature and pressure.

13. The method of claim 12, wherein synthesizing one of an inlet temperature and pressure of the gas turbine engine based on the received value includes synthesizing both an inlet temperature and an inlet pressure based on the received value.

14. The method of claim 12, wherein the synthesized inlet temperature is a temperature of air at a gas turbine engine inlet forward of a fan section, relative to an expected direction of fluid flow through the gas turbine engine.

15. The method of claim 12, wherein the synthesized inlet pressure is a pressure of air at a gas turbine engine inlet forward of a fan section, relative to an expected direction of fluid flow through the gas turbine engine.

16. The method of claim 12, wherein synthesizing one of an inlet temperature and pressure includes accounting for at least one of an engine operational mode, an engine altitude and an engine fan speed by at least incorporating the one or more of the engine operational mode, the engine altitude and the engine fan speed as a variable in a synthesizing formula in a controller.

17. A gas turbine engine comprising:
a short inlet fan section characterized by a lack of inlet temperature sensors;
a sensor disposed aft of a fan; and
a controller configured to synthesize a temperature and/or pressure of a fluid at an inlet of the short inlet fan section based on a temperature and/or pressure at said sensor.

18. The gas turbine engine of claim 17, wherein the sensor is further configured to sense both a temperature and pressure of a fluid, and wherein the controller is further configured to synthesize a temperature and a pressure of the fluid at the inlet of the short inlet fan section.

19. The gas turbine engine of claim 17, wherein the short inlet fan section is defined by a dimensional relationship L/D of between 0.2 and 0.45, where L is a distance from an inlet to a leading edge of at least one fan blade and D is a diameter of the fan.

20. The gas turbine engine of claim 17, wherein the sensor is disposed aft of a primary flowpath inlet.
